(19) United States
(12) Patent Application Publication
(10) Pub. No.: US 2020/0058083 A1
(43) Pub. Date: Feb. 20, 2020

(54) SYSTEM AND METHOD TO MEASURE WELL-BEING IN AN INDOOR SPACE

(71) Applicant: RUBIX S&I, Toulouse (FR)

(72) Inventor: Jean-Christophe Mifsud, Goudourville (FR)

(21) Appl. No.: 16/342,936

(22) PCT Filed: Oct. 10, 2017
(86) PCT No.: PCT/EP2017/075840

§ 371 Date: Apr. 17, 2019

(30) Foreign Application Priority Data
Oct. 18, 2016 (FR) 1660106

(51) Int. Cl. G06Q 50/06; G05B 15/02

(52) U.S. Cl. CPC G06Q 50/06; G05D 23/19; G05B 15/02

(57) ABSTRACT

The invention relates to a system for measuring well-being in at least one inner space, said measuring system comprising: a computer server, at least one monitoring module arranged in the inside space, said monitoring module comprising means for measuring at least one objective environment parameter in the vicinity of said monitoring module and communication means designed to transmit the objective environment measurement to the computer server, and means for transmitting a subjective measurement of the environment to the computer server in such a way as to form a refined environment ratio temporally correlating the objective measurement and the subjective measurement.

### TECHNICAL FIELD

This invention is related to the field of measuring well-being, safety and painfulness in an indoor space, particularly in a building. Such a system allows, in particular, a company to ensure the well-being of its employees as they accomplish their work.

It is known that the indoor space of a building, such as offices or shops, is designed to receive people, especially workers and the public. This indoor space being more or less closed, people's comfort must be assured. Also, it is known to install various systems to improve air quality in a building, such as a ventilation system to circulate the air between the indoor and outside of a building, a heating system or an air conditioning system, etc.

In practice, in order to measure people's well-being, specific and localised measurements are taken in the building (temperature, noise level, level of carbon dioxide, etc.) which are extrapolated in order to determine a level of discomfort. Such a measurement of well-being is imperfect, as it assumes that the level of discomfort is the same for all areas of the building, and at any moment of the day. It does not allow to determine reliably a painfulness degree for each person, the personal feeling not being taken into account.

Finally, such a measurement of well-being does not allow to determine the sources of discomfort or painfulness, which doesn't allow the building operator to improve people's comfort.

One of the goals of this invention is to propose a system which allows to measure reliably and precisely well-being in an indoor space in order to allow to locate and to identify all sources of discomfort for the people in said indoor space.

### SUMMARY

In order to eliminate these disadvantages, the present invention is a measurement system for well-being in at least one indoor space, said measurement system comprising:
a computer server,
at least one monitoring module placed in the indoor space, said monitoring module comprising measuring means of at least one objective environmental parameter surrounding said monitoring module, and communication means configured for transmitting the objective environmental measurement to the computer server, and
means to transmit a subjective environmental measurement to the computer server in in order to create a refined environmental report correlating the objective measurement and subjective measurement in time.

An advantage is that the well-being measurement system and the remaining painfulness is monitored on the one hand, using one or more objective measurements, and, on the other hand, a subjective measurement obtained surrounding each monitoring module. An advantage of the invention is that the objective environmental measurements form advanced indicators of the subjective measurement. Thanks to a refined environmental report, one can also deduce subjective discomfort from the objective measurements. The computer server can thus form a refined environmental report correlating objective discomfort and subjective discomfort in order to precisely determine the type, the degree of discomfort, the location and the time of the sources of painfulness. Thanks to this refined environmental report, one can improve the well-being of people in the indoor space.

Well-being can be understood as the measurement of air temperature, the level of humidity in the air, the level of carbon dioxide in the air, the noise level, an odour, a luminosity measurement, toxic level, a vibration level, a radiation level, etc.

Preferably, the monitoring module comprises the means to transmit a subjective measurement. Thus, the objective measurement and the subjective measurement are performed in the immediate surrounding of the monitoring module. The activation of the means to transmit on the monitoring module allows an immediate correlation of the objective measurement with the subjective one, which is advantageous for the operator who would like to know precisely the sources of discomfort. An advantage is that a combination of subjective measurements can be associated with discomfort.

In a preferred way, the means to transmit a subjective measurement are presented in the form of an activation system using mechanical pressure, sound activation, measurement of movements, etc. Such means to transmit are simple to activate by the user, who can then spot a source of discomfort immediately.

According to one aspect of the invention, the means to transmit a subjective measurement are presented in the form of a terminal configured for emitting a subjective measurement associated to said monitoring module. Thus, the subjective measurement is issued independently of the physical structure of the monitoring module. This is particularly advantageous if the monitoring module is fixed at a height that cannot be accessed by a user. In addition, using a terminal can provide an enhanced subjective measurement wherein the user can give details on his discomfort. In addition, the use of a terminal allows several users to give subjective measurements as a function of their personal feeling.

In an advantageous manner, the monitoring module comprises identification means; the terminal is configured to read said identification means in a way that it can associate the subjective measurement of said identified monitoring module. Thus, a user can inform the computer server of a discomfort in a given area by previously identifying the monitoring module of the given area. All users can thus attest of their discomfort in a practical manner. Subjective measurements can thus be processed automatically by the computer server to create a refined environmental report.

In a preferred way, the objective environmental parameter(s) are chosen from among the following: air temperature, humidity, odour, noise, particles, allergens, vibrations, radiation, radiance and luminosity.

In a preferred embodiment, the monitoring module comprises a housing wherein measuring means and communication means are mounted, this housing comprising a lower face comprising at least one entry opening and an upper part comprising at least one exit opening, each monitoring module comprises ventilation means configured to circulate an air flow between the entry opening and the exit opening. Such ventilation means optimally supply the measuring means in order to monitor ambient air. In addition, such ventilation means are advantageous to trap heavy particles in the measurement equipment. Locating the measuring means in a housing can protect and thus improve the relevance of the measurements performed.

Preferably, the monitoring module comprises a fixation base positioned on the lower face and connected to said housing by spacing means so as to form an air inlet between the lower face and the fixation base. Thus, the module can rest on the lower face while being supplied with air from the lower face of its housing.

In a preferred embodiment, the air inlet is peripheral. Thus, the measuring means obtain relevant measurements surrounding the monitoring module.

Preferably, the communication means are able to communicate by radio with said computer server. According to a preferred embodiment, each monitoring module has an independent electrical supply. Thus, each monitoring module can be placed independently and without constraint in a user's environment, for example on a desk or a workstation.

Preferably, the monitoring module comprises objective alarm means configured to emit an alarm if at least one objective measurement of an environmental parameter exceeds a predetermined threshold. Thus, the monitoring module can notify a user of an objective discomfort. The user can then conduct, in a reactive manner, corrective actions (ventilation, heating, etc.) in order to avoid painfulness.

In a preferred embodiment, the system comprises a plurality of monitoring modules placed respectively in a plurality of indoor spaces. The pooling of several monitoring means allows to determine if the source of discomfort is felt by one or more users as well as the geographical propagation of the source of discomfort over time.

In a preferred embodiment, measuring means include one or more sensors. Said in another way, one single sensor can measure several different environmental parameters, or several sensors can each measure a different environmental parameter.

In a preferred embodiment, the computer server is configured to calculate a comfort score associated to each monitoring module as a function of the measurements received by said monitoring module. In a preferred manner, the refined environmental report also comprises the discomfort score. Thus, an operator can establish a list of sources of discomfort to remove in a priority manner.

According to one aspect of the invention, the computer server is integrated to the monitoring module which is thus autonomous.

The invention also concerns a method to measure well-being in at least one indoor space using a measurement system as presented above, the monitoring module being placed in an indoor space, and the method comprises:
a measurement stage by the monitoring module, of at least one objective parameter of the environment surrounding said monitoring module,
a transmission stage by the monitoring module of the objective environmental measurement to the computer server,
a transmission stage, by a user, of a subjective environmental measurement to the computer server associated to said monitoring module, and
a time correlation stage, by the computer server, of the objective environmental measurement with the subjective environmental measurement in order to create a refined environmental report which measures well-being in said indoor space.

### DESCRIPTION OF THE DRAWINGS

The invention is better understood by reading a description which will follow, in the way of examples, and referring to attached figures wherein:

FIG. 1 is a schematic representation of an embodiment of a measurement system according to the invention installed in a building comprising several zones,

FIG. 2 is a representation in perspective of an embodiment of a monitoring module according to the invention;

FIG. 3 is an exploded top-view of the monitoring module shown in FIG. 2;

FIG. 4 is an exploded below view of the monitoring module shown in FIG. 2;

FIG. 5 is a schematic representation of a transmission stage of an objective measurement to a computer server; and

FIG. 6 is a schematic representation of a transmission stage of a subjective measurement to a computer server.

It should be noted that the figures present the invention in a detailed manner to implement the invention, said figures, can of course, be used to better define the invention, if so.

### DETAILED DESCRIPTION

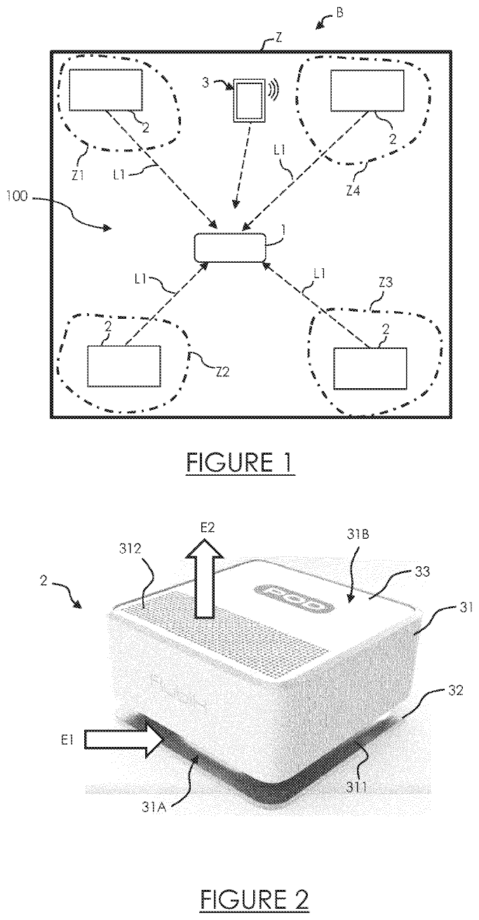

FIG. 1 represents in a schematic way a measurement system 100 of well-being according to one embodiment of the invention. In this example, a measurement system is shown for physical and chemical nuisances indoor a building as offices or conference rooms, in particular at the users' workstations. It goes without saying that the invention applies to all types of buildings (factory, workshop, airport, hotel, etc.) and, more generally, to all indoor spaces, especially those of a vehicle.

FIG. 1 represents an office building B delimiting an interior space Z. Such building B comprises four work areas Z1-Z4 wherein users are working. As is then presented, environmental quality can be measured individually for each work zone Z1-Z4 using a measurement system 100 according to the invention in order to be able to estimate the comfort of the users.

In this embodiment, as shown in FIG. 1, the measurement system 100 comprises a computer server 1 and a plurality of monitoring modules 2 placed at different positions in said indoor space Z. In this example, a monitoring module 2 is placed in each of the work areas Z1-Z4, but it goes without saying that the number of monitoring modules 2 and their positions can be different in the indoor space Z. It goes without saying that the invention also applies to a measurement system 100 which only comprises one monitoring module 2.

Thereafter, the monitoring modules 2 and the computer server 1 are successively presented.

In this example, the monitoring modules 2 are all identical, but it goes without saying that they could be different. In order to provide precision and clarity, one single monitoring module 2 can thereafter be presented.

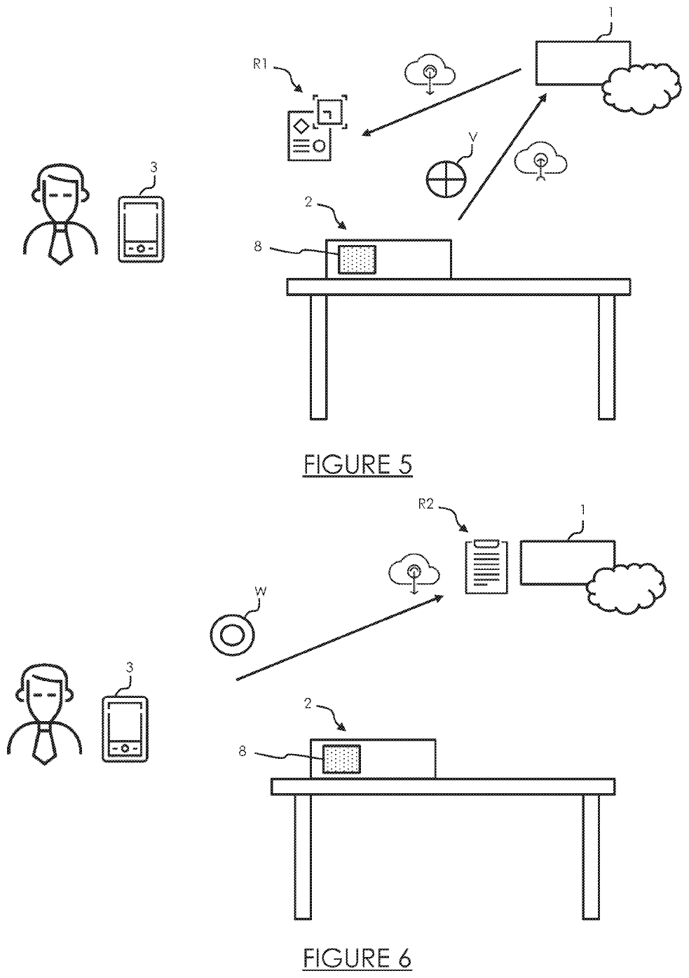

According to the invention, a monitoring module 2 allows, on the one hand, to measure one or several objective quality parameters of the environment (work areas Z1-Z4) and, on the other hand, to transmit them to the computer server 1 in order for this one to aggregate and process them. In this example, the objective measurements performed by the monitoring module 2 are transmitted periodically in the form of a measurement vector V (FIG. 5).

In a preferred embodiment, each monitoring module 2 is placed near a user, notably in an office, in order to monitor environmental quality surrounding said user, and to gather his subjective perception.

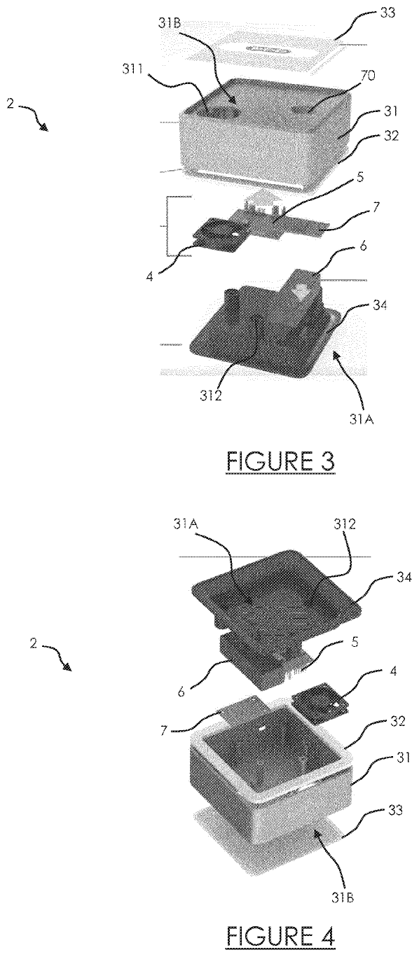

In reference to FIGS. 3 and 4, a monitoring module 2 comprises a housing 31 wherein are mounted the measuring means, the ventilation means and the communication means which are presented thereafter.

In this embodiment, the housing 31 has a block shape defining six faces, but it goes without saying that its shape could be different. In a preferred embodiment, the largest dimension of the housing 31 is less than 50 cm, preferably 15 cm, in order to remain compact and not cumbersome.

In this example, the housing 31 comprises a lower face 31A comprising at least an entry opening 311 and an upper face 31B comprising at least one outlet opening 312. Thus, the monitoring module 2 can take measurements in circulating air from the lower face 31A to the upper face 31B.

Preferably, in reference to FIG. 3, the monitoring module 2 comprises a fixation base 32 positioned regarding the lower front 31A and connected to said housing 31 by spacing means so as to form an air inlet E1 between the lower face 31B and the fixation base 32. As an example, the spacing means are presented in the form of spacing columns. In this example, the air inlet E1 is peripheral so that it can measure the air situated surrounding the monitoring module 2.

In an advantageous manner, the fixation base 32 can be fixed to a vertical wall, a ceiling or placed on a table without disturbing incoming air of the fixation base. In a preferred embodiment, when used, the fixation base 32 is horizontal and placed under the housing 31 as illustrated in FIG. 2 in a way that it can best measure heavy particles (pollen, mites, etc.).

In this example, referring to FIGS. 3 and 4, the monitoring module 2 also comprises a bracket 34 which is partially mounted in the housing 31.

In this embodiment, in a preferred manner, the monitoring module 2 also comprises ventilation means 4, configured to create air circulation in the housing 31, notably between its lower face 31A and its upper face 31B. In this example, ventilation means 4 are presented in the form of a fan, but it goes without saying that other means could be appropriate. Preferentially, the axis of the fan is orientated vertically to provide the best ventilation between the lower face 31A and the upper face 31B.

The monitoring module 2 comprises measurement means of several objective environmental parameters surrounding the monitoring module 2. Notably, the monitoring module 2 is able to measure several circulating air quality parameters in the housing 31. In a preferred embodiment, the air quality parameters are air temperature, humidity level in the air, carbon dioxide level in the air, an odour, etc.

In this example, the monitoring module 2 also comprises measuring means of other objective environmental parameters surrounding the monitoring module 2. In a preferred embodiment, the environmental quality parameters are luminosity, toxicity, vibrations, radiations, etc. Such parameters are objective information which can objectively qualify the quality of an environment.

The measuring sensors can be: a gas sensor, a temperature sensor, a humidity sensor, a carbon dioxide sensor, an odour sensor, a noise sensor, a luminosity sensor, a vibration sensor, a radiation sensor, an allergen sensor, a toxic chemicals sensor, etc. Such measuring sensors are known by the person skilled in the art and are not presented in further details.

In this example, in reference to FIGS. 3 and 4, the monitoring modules 2 include a gas sensor 6 mounted on a bracket 34 of the housing 31 and orientated perpendicularly to the circulating vertical air flow in the housing 31.

Communications means of the monitoring module 2 are configured to communicate with the computer server 1 via a first communication link L1 as illustrated in FIG. 1. Preferably, the first communication link L1 is a radio link, that is, wireless, notably a GPRS type, W-Fi, Bluetooth, LoRa, zigbee or similar in a way that the monitoring module 2 can be placed without restriction in the indoor space Z, closest to potential sources of discomfort. It goes without saying that a physical connection can also be used.

The monitoring module 2 also comprises an electricity supply (not represented) which is presented, in this example, in the form of a rechargeable electric battery by a USB cable. Other means of electrical supply can also be used (battery, sector supply, etc.). In a preferred embodiment, the monitoring module 2 is electrically independent in order to be placed without restriction. Environmental quality can be measured in each zone Z1-Z4 in the indoor space Z easily and at low cost.

In this example, the monitoring module 2 comprises an electronic card 5 wherein the measuring means (measuring sensors) and the communications means (radio and/or network component) are mounted. The electronic card 5 also comprises calculation means, notably a processor, in order to form a measurement vector V comprising the different objective measurements realised at a given moment. The objective measurements are transmitted to a computer server 1 in order to be processed.

As an option, the monitoring module 2 can comprise display means, such as a LCD screen which can display information about the environmental quality or the threshold overrun by one of the objective environmental parameters in order to notify a user. It goes without saying that the monitoring module 2 can comprise other alarm means to notify a user of a threshold overrun of a an objective environmental parameter, in particular a sound alarm or a visual alarm.

In this example, referring to FIGS. 3 and 4, the monitoring module 2 also comprises an additional electronic card 7 on which a light sensor is mounted. To this end, the housing 31 comprises, in its upper face 31B, a dedicated upper measurement opening 70 to hold the additional electronic card 7.

In this embodiment, the monitoring module 2 comprising an upper cap 33 mounted on the upper face 31B of the housing 31 in order to hide the openings 311, 70, and thus improve the aesthetic aspect of the monitoring module 2. The upper cap 33 is perforated in order to allow exiting air flow E2 and is translucid in order light detection.

According to the invention, the measurement system 100 comprises means to transmit a subjective measurement to the computer server 1 in a way which forms a refined environmental report correlating in time with the subjective measurement and the objective measurement.

The correlation of the objective measurement and the subjective measurement allows to bring together in time the objective effects of the environmental parameters and how they are felt by the operators. Thus, even if the objective parameters do not individually exceed the tolerance thresholds, these can lead in a synergistic way to cause discomfort to users. Thanks to a refined environmental report, a building operator can advantageously know when uncomfortable situations occur and associate them in a reliable way to objective environmental parameter measurements. Thus, the operator can prevent discomfort from recurring.

In one embodiment, the monitoring module comprises the means to transmit a subjective measurement. Said another way, the means to transmit are integrated to the monitoring module 2.

As an example, the monitoring module comprises a movement detection means which allows to detect a change in the position of the monitoring module 2, in particular, a change to the orientation of the housing 31. Such a movement detection means in particular comprises a gyroscope, and allows to detect if the face of the housing 31 supported by the desk, has been modified. It goes without saying that the means to transmit can have different forms, in particular, a sound detector, an activation button, etc. The significant thing is that the user can easily act on the monitoring module 2 in order to signal discomfort, and thus correlate said discomfort with the objective measurements conveyed with the transmission of the discomfort signal. In this embodiment, the subjective measurement is transmitted to the computer server 1 with the objective measurements presented above. In an advantageous manner, as the subjective measurement is directly transmitted by the monitoring module 2, the subjective measurement is directly associated to said monitoring module 2, which facilitates the establishment of the refined environmental report R2 (FIG. 6).

In a second embodiment, the means to transmit a subjective measurement are presented in the form of a terminal 3 configured to emit a subjective measurement associated to said monitoring module 2.

In this example, in reference to FIGS. 1, 5 and 6, the measurement system 100 comprises a terminal 3, independent of the monitoring module 2, fitted to receive and read a raw environmental report R1, issued by the computer server 1, tied to a given monitoring module 2. Said differently, the terminal 3 allows a user to receive a report of the objective measurements taken by the monitoring module 2.

The terminal 3 is configured to enter subjective data W in relation to the objective data of the raw environmental report R1, and to transmit them to the computer server 1. As an example, the raw environmental report R1 can indicate a strong odour and a high temperature. The user can then indicate, using his terminal 3, that the odour corresponds to the team meal in the meeting room (no discomfort), while the high temperature corresponds to the overheating of a video projector due to direct sunshine (discomfort). These subjective data are then sent to the computer server 1, which can establish a refined environmental report R2, which represents well-being.

This terminal 3 is capable of providing a detailed subjective measurement, in particular in giving the nature and degree of the discomfort.

The terminal 3 can in particular be an intelligent telephone, a smart phone or a tablet which the user can manipulate. In a preferred embodiment, the terminal 3 is connected to the computer server 1 by the Internet network using a dedicated IT application which has been installed previously on said terminal 3. Preferentially, the terminal 3 communicates by radio with the IT network.

In a preferred embodiment, the monitoring module 2 comprises identification means presented in the form of an RFID marker, an intelligent code (QR code, etc.) or analogue code present on the housing 31 of the monitoring module 2. The monitoring module 2 can also emit an identification signal, for example, a Bluetooth® or equivalent.

Preferentially, the terminal 3 is configured to read the identification means of the monitoring module 2 in a way to associate the subjective measurement to the identified monitoring module 2.

In reference to FIG. 1, the computer server 1 is suited for receiving objective measurements transmitted by the monitoring modules 2. Such a computer server 1 can be placed indoor the building B, especially in the indoor space Z, but can also be moved outside of building B. The computer server 1 is also able to receive subjective measurements issued by the monitoring module 2 or another equipment (terminal 3, etc.).

In a preferred embodiment, the computer server 1 is linked to monitoring modules 2 via the Internet network. In a preferred embodiment, the computer server 1 can in particular receive objective measurement vectors V of different monitoring modules 2.

In a complementary manner, the computer server 1 is configured to emit an alarm if at least one objective measurement exceeds a predetermined threshold. In addition, under another optional embodiment, the computer server 10 is connected to an air conditioning system and/or lighting system which is controlled as a function of the measurements obtained in order to reduce users' discomfort.

As will be presented in reference to FIGS. 5 and 6, the computer server 1 can aggregate the objective measurement vectors V in order to establish a raw environmental report R1 and a refined environmental report R2 using subjective measurements obtained W. As will be presented below, such reports R1, R2 enable the building B operator to determine sources of discomfort as a function of each zone Z1-Z4 and of the time of day. One can also easily create a correlation between the users' perceived comfort and the objective measurements V of the environmental quality. The operator can therefore take the appropriate measurements to determine the source of discomfort, and to eliminate it.

An embodiment of the procedure to measure well-being in an open space office using the measurement system 100, such as that presented above, is presented below. In this example, the subjective measurement W is transmitted by a terminal 3, but it goes without saying that it could be directly transmitted by the monitoring module 2 following an action by the user.

The open office in this example comprises four work areas Z1-Z4 wherein four users respectively work, each equipped with a monitoring module 2. As each monitoring module 2 is independent, it can simply be placed where one wishes to monitor environmental quality. In reference to FIGS. 5 and 6, a monitoring module 2 is placed on a table.

During its use, the sensors of each monitoring module 2 periodically measure the different environmental quality parameters (air, noise, luminosity, etc.) surrounding the monitoring module 2, in other words, in the user's work environment. In reference to FIG. 5, the monitoring module 2 periodically sends an objective measurements vector V to the computer server 1.

In this example, the user smells a nauseating odour. In reference to FIG. 5, the user reads the identification means 8 of the monitoring module 2 thanks to his terminal 3 in order to obtain a raw environmental report R1 sent by the computer server 1. The raw environmental report R1 comprises recent objective measurements of environmental parameters. In this example, the raw environmental report R1 also indicates if a measurement has exceeded a predetermined threshold.

On terminal 3, the user checks the raw environmental report R1 which indicates a strong odour. The user then sends his subjective discomfort measurement W to the computer server, which indicates that the odour is disagreeable. The computer server can then establish a refined environmental report R2 which correlates the objective measurements V and the subjective measurements W of one or more users. In an advantageous manner, following reading of the identification means 8 of the monitoring module 2, the subjective measurement W is associated to said monitoring module 2.

In an advantageous manner, the objective measurements detect early the source of discomfort before the user is disturbed. In addition, the report shows that several different work areas Z1-Z4 had detected a nauseating odour at different times. In this case, one can deduce that the discomfort corresponds to an industrial uncapping stage performed in the neighbouring building, and during which effluents are drained surrounding the work areas Z1-Z4. The operator can advantageously shift the draining to a different time of day, in order not to annoy the users anymore.

Thanks to the receipt of objective and subjective information, the system 100, according to the invention, takes into account the users' feelings in order to optimise their comfort. A correlation of objective measurements and subjective measurements allows to obtain a refined environmental report R2 which is relevant. The operator has reliable and legible information related to users' painfulness.

The invention has been presented for employees in a company, but it can be applied to shops, schools and others.

1. A measurement system for well-being in at least one indoor space, said measurement system comprising:
a computer server,
at least one monitoring module placed in the indoor space, said monitoring module comprising measuring means of at least one objective environmental parameter surrounding said monitoring module, and communication means configured for transmitting the objective environmental measurement to the computer server, and
a means to transmit a subjective environmental measurement to the computer server in order to create a refined environmental report correlating the objective measurement and subjective measurement in time.

2. The system according to claim 1 wherein the monitoring module comprises the means to transmit a subjective measurement.

3. The system according to claim 1 wherein the means to transmit a subjective measurement are presented in the form of a terminal configured for emitting a subjective measurement associated to said monitoring module.

4. The system according to claim 3 wherein, the monitoring module comprises identification means; the terminal is configured to read said identification means in a way that it can associate the subjective measurement of said identified monitoring module.

5. The system according to claim 1 wherein the objective environmental parameter(s) are chosen from among the following: air temperature, humidity, odour, noise, particles, allergens, vibrations, radiation, radiance and luminosity.

6. The system according to claim 1 wherein the monitoring module comprising a housing wherein measuring means and communication means are mounted, the housing comprising a lower face comprising at least one entry opening and an upper face comprising at least one exit opening, each monitoring module comprises ventilation means configured to circulate an air flow between the entry opening and the exit opening.

7. The system according to claim 6 wherein the monitoring module comprises a fixation base positioned on the lower face and connected to said housing by spacing means so as to form an air inlet between the lower face and the fixation base.

8. The system according to claim 7 wherein the air inlet is peripheral.

9. The system according to claim 1 wherein the system comprises a plurality of monitoring modules placed respectively in a plurality of indoor spaces.

10. A method to measure well-being in at least one indoor space using the measurement system according to claim 1, the monitoring module being placed in an indoor space, and the method comprises:
a measurement stage by the monitoring module, of at least one objective parameter of the environment surrounding said monitoring module,
a transmission stage by the monitoring module of the objective environmental measurement to the computer server,
a transmission stage, by a user, of a subjective environmental measurement to the computer server associated to said monitoring module, and
a time correlation stage, by the computer server, of the objective environmental measurement with the subjective environmental measurement in order to create a refined environmental report which measures well-being in said indoor space.
